(19) United States
(12) Patent Application Publication
(10) Pub. No.: US 2026/0225901 A1
(43) Pub. Date: Aug. 6, 2026

(54) HYDROGEN ADSORPTION MATERIAL AND METHOD FOR PRODUCING THE SAME

(71) Applicants: TOYOTA JIDOSHA KABUSHIKI KAISHA, Toyota-shi (JP); University of Tsukuba, Tsukuba-shi (JP); TOYODA GOSEI CO., LTD., Kiyosu-shi (JP)

(72) Inventors: Yusuke UMETANI, Susono-shi (JP); Hiroaki SAITOH, Mishima-shi (JP); Takahiro KONDO, Tsukuba-shi (JP); Osamu OKI, Tsukuba-shi (JP); Miwa HIKICHI, Tsukuba-shi (JP); Takaki KURIBAYASHI, Kiyosu-shi (JP); Atsuki YOSHIMURA, Kiyosu-shi (JP)

(73) Assignees: TOYOTA JIDOSHA KABUSHIKI KAISHA, Toyota-shi (JP); University of Tsukuba, Tsukuba-shi (JP); TOYODA GOSEI CO., LTD., Kiyosu-shi (JP)

(21) Appl. No.: 19/466,910

(22) Filed: Feb. 2, 2026

(30) Foreign Application Priority Data
Feb. 3, 2025 (JP) 2025-016157

(51) Int. Cl. C01B 35/04

(52) U.S. Cl. CPC C01B 35/04; C01P 2002/82

(57) ABSTRACT

One aspect of the present disclosure relates to a lithium-modified hydrogen boride containing lithium and hydrogen boride, wherein in measurement of an IR spectrum by an attenuated total reflection method, an absorption peak is observed in the range from 1100cm⁻¹or more to 1500cm⁻¹ or less, and the absorption peak is overlapping peaks consisting of an absorption peak (Ia) having a maximum value in the range from 1300cm⁻¹or more to 1400cm⁻¹ or less, and an absorption peak (Ib) having a maximum value in the range from 1200cm⁻¹ or more to1300cm⁻¹ or less.

### CROSS-REFERENCE TO RELATED APPLICATION

This application claims priority to Japanese Patent Application No. 2025-016157 filed on February 3, 2025. The disclosure of the above-identified application, including the specification, drawings, and claims, is incorporated by reference herein in its entirety.

### BACKGROUND

### 1. Technical Field

One aspect of the disclosure relates to a hydrogen adsorption material and a method for producing the same.

### 2. Description of Related Art

In recent years, hydrogen has been attracting attention as a clean energy source in the pursuit of decarbonization. In fuel cell electric vehicles, hydrogen is charged at a high pressure (70 MPa), and there is a need for technologies that allow hydrogen to be stored at a lower pressure with lower weight and higher density than compressed gas.

For example, Japanese Unexamined Patent Application Publication No. 2023-151415 (JP 2023-151415 A) discloses a metal-supported two-dimensional boron sheet-containing material having a two-dimensional network containing (MₓH₁₋ₓB)ₙ (wherein M is an alkali metal atom or a Group 2 element, H is a hydrogen atom, B is a boron atom, 0.01 ≤ x ≤ 1, and n ≥ 6), wherein B atoms are arranged in a hexagonal ring, hexagons formed by the B atoms are connected to one another to constitute a mesh-like two-dimensional network, and at least the M and the B are bonded through three-center two-electron bonding or two-center two-electron bonding.

### SUMMARY

It has been reported that, when alkali metal atoms and/or alkaline earth metal atoms can be dispersed and introduced at the atomic level into hydrogen boride (HB), the hydrogen adsorption capacity of a resulting composite compound increases according to theoretical calculations (Phys. Chem. Chem. Phys., 2018, 20, 30304 - 30311 and International Journal of Hydrogen Energy, 2021, 46, 39273 - 39283).

As a method for introducing alkali metal atoms or alkaline earth metal atoms into a compound, for example, deposition under vacuum may be employed. When the deposition is employed, however, the alkali metal atoms or alkaline earth metal atoms tend to aggregate, and it has been difficult to disperse these atoms at the atomic level and uniformly introduce these into a powder sample.

In addition, as described in JP 2023-151415 A, there is also a method in which an alkali metal or alkaline earth metal is used in the form of a salt to be ionized in a solvent, and the resultant is mixed with a compound, and then dried for introducing the metal. However, in this case, the atoms are introduced into the compound in an ionized state, and it is difficult to introduce the material in atomic form.

Accordingly, in the related art, neither hydrogen adsorption materials exhibiting sufficient hydrogen adsorption capacity nor methods for easily producing such hydrogen adsorption materials have been established.

Therefore, an object of one aspect of the present disclosure is to provide a hydrogen adsorption material having a high hydrogen adsorption capacity, and a method for easily producing the same.

The present inventors have conducted extensive studies on means for solving the above‑described problems. As a result, the present inventors have found that when lithium metal and hydrogen boride are mixed under applied shear force, a lithium‑modified hydrogen boride thus obtained exhibits an increased hydrogen adsorption capacity. In this manner, the present inventors have accomplished one aspect of the present disclosure.

Specifically, the gist of one aspect of the present disclosure is as follows:
(1) A lithium-modified hydrogen boride containing lithium and hydrogen boride, wherein in measurement of an IR spectrum by an attenuated total reflection method, an absorption peak is observed in the range from1100cm⁻¹ or more to 1500cm⁻¹ or less, and the absorption peak is overlapping peaks consisting of an absorption peak (Ia) having a maximum value in the range from 1300cm⁻¹ or more to 1400cm⁻¹ or less, and an absorption peak (Ib) having a maximum value in the range from1200cm⁻¹ or more to 1300cm⁻¹ or less.
(2) The lithium-modified hydrogen boride according to (1), wherein the area ratio (Ia/Ib) between the separated absorption peak (Ia) and absorption peak (Ib) is in the range from 0.5 or more to 0.8 or less.
(3) The lithium-modified hydrogen boride according to (1) or (2), wherein the molar ratio (B/Li) between boron and lithium calculated by ICP is in the range of 0.8 or more.
(4) The lithium-modified hydrogen boride according to any one of (1) to (3), wherein the molar ratio (H/B) between hydrogen calculated by TPD and boron calculated by ICP is in the range of 1.2 or less.
(5) The lithium-modified hydrogen boride according to any one of (1) to (4), having, in a temperature-hydrogen intensity curve obtained by TPD measurement, a hydrogen desorption peak with a peak top present in the range from 500°C or more to 600°C or less.
(6) A method for producing a lithium-modified hydrogen boride containing lithium and hydrogen boride, the method including mixing lithium metal and hydrogen boride under applied shear force.
(7) The method according to (6), wherein the mixing is performed under an inert atmosphere with a mortar and pestle.

One aspect of the present disclosure provides a hydrogen adsorption material having a high hydrogen adsorption capacity and a method for easily producing the same.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating the structure of a lithium‑modified hydrogen boride according to one aspect of the present disclosure (in which the molar ratio between hydrogen and boron (H/B) is 1);

FIG. 2A is a graph illustrating the hydrogen adsorption capacities of Li/HB, HB, and LiB₂ at 298 K under various pressures;

FIG. 2B is a graph illustrating the hydrogen adsorption capacities of Li/HB and HB at

77 K under various pressures;

FIG. 3A is a graph illustrating the IR spectrum of HB measured by an attenuated total reflection (ATR) method;

FIG. 3B is a graph illustrating the IR spectrum of Li/HB measured by the attenuated total reflection (ATR) method;

FIG. 4A is a graph illustrating the EEM spectrum of HB;

FIG. 4B is a graph illustrating the EEM spectrum of Li/HB;

FIG. 5A is a graph illustrating the hydrogen desorption capacity of HB at various temperatures; and

FIG. 5B is a graph illustrating the hydrogen desorption capacity of Li/HB at various temperatures.

### DETAILED DESCRIPTION OF EMBODIMENTS

Now, preferred embodiments of one aspect of the present disclosure will be described in detail. Herein, the features of one aspect of the disclosure will be described with reference to the accompanying drawings as appropriate. In the drawings, the dimensions and shapes of respective parts are exaggerated for clarity and are not depicted with actual accuracy. Accordingly, the technical scope of one aspect of the present disclosure is not limited to the dimensions and shapes of the respective parts as illustrated in these drawings. It should be noted that a hydrogen adsorption material and a method for producing the same according to one aspect of the present disclosure are not limited to the embodiments described below, and may be implemented in various forms with modifications, improvements, and the like that can be made by those skilled in the art without departing from the gist of the one aspect of the present disclosure.

A lithium-modified hydrogen boride according to one aspect of the present disclosure contains lithium and hydrogen boride.

In the IR spectrum, measured by an attenuated total reflection (ATR) method, of the lithium‑modified hydrogen boride of one aspect of the present disclosure, an absorption peak (hereinafter also referred to as the peak (Iab)) is observed in the range from 1100cm⁻¹ or more to 1500cm⁻¹ or less.

The peak (Iab) is not a single absorption peak but has a shape formed by two or more overlapping absorption peaks. In one embodiment, the peak (Iab) consists of two overlapping absorption peaks, namely, an absorption peak having a maximum value (peak top) in the range from 1300cm⁻¹or more to 1400cm⁻¹ or less (hereinafter also referred to as the peak (Ia)), and an absorption peak having a maximum value in the range from 1200cm⁻¹or more to 1300cm⁻¹or less (hereinafter also referred to as the peak (Ib)). In this embodiment, the area ratio (Ia/Ib) between the separated peak (Ia) and peak (Ib) is generally in the range from 0.5 or more to 0.8 or less, and in another embodiment, is in the range from 0.6 or more to 0.7 or less.

Here, the IR spectrum measured by ATR is obtained under an inert atmosphere, for example, in an argon atmosphere, and at room temperature, for example, at a temperature of 20°C or more and 25°C or less.

In the IR spectrum of hydrogen boride measured under the same conditions, an absorption peak is observed in the range from 1100cm⁻¹or more to 1500 cm⁻¹ or less, but this absorption peak is a single peak having a maximum value present in the range from 1300 cm⁻¹ or more to 1400cm⁻¹ or less, and is presumed to be an absorption peak attributable to the vibration of B-H-B. Accordingly, in the lithium‑modified hydrogen boride of one aspect of the present disclosure, the peak (Ia) is presumed to be an absorption peak attributable to the vibration of B-H-B, and the peak (Ib) is presumed to be an absorption peak attributable to the vibration of Li-B.

Since the lithium-modified hydrogen boride of one aspect of the present disclosure has, in the IR spectrum measured by ATR, the peak consisting of two overlapping absorption peaks in the above-described range, it is understood that in the lithium‑modified hydrogen boride, lithium is uniformly dispersed at the atomic level within the hydrogen boride without being ionized.

In the lithium-modified hydrogen boride of one aspect of the present disclosure, the molar ratio between boron and lithium (B/Li), as calculated by inductively coupled plasma (ICP), is generally in the range of 0.8 or more, in the range of 1.0 or more in one embodiment, in the range of 1.2 or more in another embodiment, in the range of 1.4 or more in another embodiment, in the range of 1.6 or more in another embodiment, in the range of 1.8 or more in another embodiment, and in the range of 1.9 or more in another embodiment. The upper limit of the molar ratio between boron and lithium (B/Li) calculated by ICP is not limited. The molar ratio between boron and lithium (B/Li) calculated by ICP is generally in the range of 2.1 or less, and in the range of 2.0 or less in one embodiment.

Here, the measurement conditions for ICP are well known in the art. In one embodiment, the ICP measurement conditions involve quantitative analysis using an ICP emission spectrometer ICPS‑8100, manufactured by Shimadzu Corporation, with measurement wavelengths for lithium and boron respectively set to 670.785 nm and 249.773 nm.

Furthermore, in the lithium-modified hydrogen boride of one aspect of the present disclosure, a molar ratio between hydrogen calculated by temperature‑programmed desorption (TPD) and boron calculated by ICP (H/B) is generally in the range of 1.2 or less, and in the range of 1.1 or less in one embodiment. The lower limit of the molar ratio between hydrogen calculated by TPD and boron calculated by ICP (H/B) is not limited. The molar ratio between hydrogen calculated by TPD and boron calculated by ICP (H/B) is generally in the range of 0.9 or more, and in the range of 1.0 or more in one embodiment.

In addition, the lithium‑modified hydrogen boride of one aspect of the present disclosure has a peak that indicates the desorption of hydrogen (hydrogen desorption peak), in a temperature-hydrogen intensity curve obtained by TPD measurement, where the maximum value (peak top) exists in the range from 500°C or more to 600°C or less. More specifically, in the lithium‑modified hydrogen boride of one aspect of the present disclosure, the temperature-hydrogen intensity curve obtained by TPD measurement shows that the amount of hydrogen desorbed increases as the temperature rises from around 100°C, reaches the maximum value in the range from 150°C or more to 250°C or less, then gradually decreases while repeating increases and decreases as the temperature rises, increases again from around 360°C, reaches the maximum value in the range from 500°C or more to 600°C or less, and thereafter decreases as the temperature increases. In this case, the lithium‑modified hydrogen boride of one aspect of the present disclosure has, in the temperature-hydrogen intensity curve obtained by TPD measurement, at least a hydrogen desorption peak having a maximum value in the range from 150°C or more to 250°C or less, and a hydrogen desorption peak having a maximum value in the range from 500°C or more to 600°C or less. It should be noted that, in hydrogen boride (HB) alone, no peak indicating hydrogen desorption (having a peak top) in the range from 500°C or more to 600°C or less is observed in the temperature-hydrogen intensity curve obtained by TPD measurement.

Here, the ICP measurement conditions are as described above. The TPD measurement is carried out by quantitatively determining hydrogen generated simultaneously with heating, when a sample is heated at a heating rate of 10 K/min, in an apparatus in which a high‑sensitivity differential thermal balance is combined with a quadrupole mass spectrometer.

When the molar ratio between boron and lithium calculated by ICP, and the molar ratio between hydrogen calculated by TPD and boron calculated by ICP in the lithium-modified hydrogen boride respectively fall in the above-described ranges, it can be confirmed that lithium is stably modified onto hydrogen boride in the lithium‑modified hydrogen boride.

The lithium‑modified hydrogen boride of one aspect of the present disclosure does not exhibit luminescence even when irradiated with light having a wavelength of 250 nm or more and 650 nm or less.

It should be noted that hydrogen boride exhibits luminescence having a maximum peak around 400 nm when irradiated with light having a wavelength of 332 nm. Accordingly, since the lithium‑modified hydrogen boride of one aspect of the present disclosure does not exhibit luminescence, it can be understood that the lithium‑modified hydrogen boride is a material having different properties from hydrogen boride.

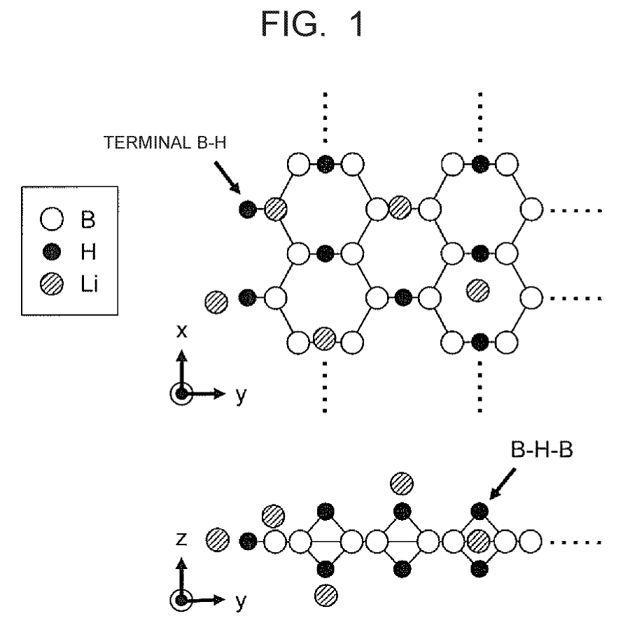

FIG. 1 illustrates the structure of a lithium‑modified hydrogen boride obtained when the molar ratio between hydrogen and boron (H/B) is 1 in the lithium‑modified hydrogen boride of one aspect of the present disclosure. B has a six‑membered‑ring network, in which B:H = 1:1, and H is present as BHB that bridges BB in the six‑membered ring, but may also form a B-H bond as terminal B-H at an edge region or around a defect site. Li is positioned above the BHB, but may alternatively be positioned at the center of the six‑membered ring, above B, and/or above H of BH. The six‑membered ring may have flexibility and need not be perfectly planar.

The hydrogen adsorption capacity of the lithium‑modified hydrogen boride of one aspect of the present disclosure is, at 298 K and relative to the total mass of the lithium‑modified hydrogen boride, in the range from 0.17% by mass or more to 0.19% by mass or less under a pressure of 2.6 MPa, in the range from 5.0% by mass or more to 5.3% by mass or less under a pressure of 6.1 MPa, and in the range from 1.0% by mass or more to 1.1% by mass or less under a pressure of 10 MPa.

The hydrogen adsorption capacity of the lithium‑modified hydrogen boride of one aspect of the present disclosure is, at 77 K and relative to the total mass of the lithium‑modified hydrogen boride, in the range from 0.057% by mass or more to 0.071% by mass or less under a pressure of 0.20 MPa, in the range from 0.25% by mass or more to 0.34% by mass or less under a pressure of 1.1 MPa, and in the range from 2.5% by mass or more to 3.0% by mass or less under a pressure of 11 MPa.

Accordingly, the lithium‑modified hydrogen boride of one aspect of the present disclosure has a hydrogen adsorption capacity that is greater than, and usually three times or more of that of, hydrogen boride alone, and hence can be used as a material for absorbing hydrogen.

The lithium‑modified hydrogen boride of one aspect of the present disclosure can be produced by a step of mixing lithium metal and hydrogen boride under applied shear force. The term "mixing under applied shear force" refers to a state in which lithium metal and hydrogen boride are mixed while being pulverized as they repeatedly undergo compression and/or elongation while contacting with and/or colliding with each other.

In one aspect of the present disclosure, the mixing is carried out under an inert atmosphere, for example, under an atmosphere of an inert gas such as nitrogen gas or argon gas.

In one aspect of the present disclosure, the mixing is not limited as long as shear force can be applied to the raw materials, and may be carried out, for example, with a pulverizer such as a mortar and pestle or a ball mill.

In one aspect of the present disclosure, the mixing time is not limited. The mixing time is generally in the range from 20 minutes or more to 40 minutes or less, and is in the range from 25 minutes or more to 35 minutes or less in one embodiment.

In one aspect of the present disclosure, the mixing temperature is not limited. The mixing temperature is generally in the range from 20°C or more to 25°C or less, and is in the range from 22°C or more to 24°C or less in one embodiment.

A method for producing a lithium-modified hydrogen boride according to one aspect of the present disclosure is as follows.

(1) A physical mixture is obtained by physically mixing lithium metal and hydrogen boride. Here, the term "physical mixing" refers to stirring the lithium metal and the hydrogen boride, for example, by placing them in a sealed container and moving the container up and

down and/or rotating it until a uniform state is achieved.

(2) The physical mixture is hand‑milled using an agate mortar under an inert gas atmosphere. The hand‑milling is carried out for a period of the mixing time at the mixing temperature described above.

(3) In order to remove adsorbed water and the like, vacuum drying is carried out at a temperature in the range from 60°C or more to 100°C or less, for example at 80 °C, for a period in the range from 16 hours or more to 48 hours or less, for example for about 32 hours.

In one aspect of the present disclosure, by mechanochemically mixing lithium metal and hydrogen boride under applied shear force, it is possible to easily produce a lithium‑modified hydrogen boride in which lithium is uniformly dispersed at the atomic level in the hydrogen boride without being ionized.

Hereinafter, several examples relating to one aspect of the present disclosure will be described, and it is not intended that one aspect of the present disclosure be limited to these examples.

### 1. Preparation of Lithium-modified Hydrogen Boride

(1) HB (185.8 mg) and metal Li (15.6 mg) cut into small pieces with scissors were prepared.

(2) The HB and Li prepared in (1) were hand‑milled and mixed with a mortar for 30 minutes at 25°C in a glove box under an argon atmosphere.

(3) After the mixing in (2), a gray product (120.6 mg, also referred to as "Li/HB") was obtained.

The obtained Li/HB was subjected to ICP measurement. For the ICP measurement, quantitative analysis was carried out using an ICP emission spectrometer ICPS‑8100, manufactured by Shimadzu Corporation, with measurement wavelengths for lithium and boron respectively set to 670.785 nm and 249.773 nm. As a result, while the feed molar ratio was HB:Li = 1:0.14, the molar ratio determined by ICP was B:Li = 1:0.52 (0.66:0.34).

### 2. Evaluation of Lithium-modified Hydrogen Boride

### 2-1. Evaluation of PCT (P: pressure, C: adsorption capacity, T: temperature)

In the Li/HB produced as described above, HB, and LiB₂, the hydrogen adsorption capacity at each pressure was measured at 298 K (25°C) or 77 K using a BELSORP‑HP manufactured by MicrotracBEL. The Li:B molar ratio of the LiB₂ used as a comparative example was 3:7 according to ICP measurement. Each sample was subjected to a pretreatment heating (80°C, degassed for 32 hours) prior to the measurement. For the measurement at room temperature (298 K), a sample tube holding the sample was immersed in a thermostatic bath (at 298K). For the measurement at 77 K, the sample tube was immersed in a Dewar vessel filled with liquid nitrogen.

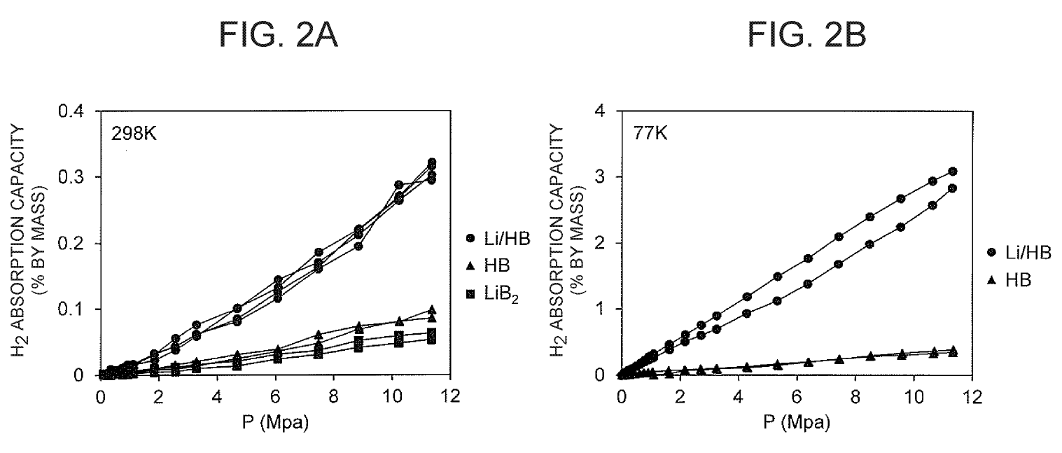

The results are illustrated in FIGS. 2A and 2B. In FIGS. 2A and 2B, at 298 K, the measurement of Li/HB was conducted four times, and the measurements of HB and LiB₂ were each conducted twice, and at 77 K, the measurements of Li/HB and HB were each conducted twice. It was found, from FIGS. 2A and 2B, that, under the temperature conditions of 298 K and 77 K, the obtained Li/HB exhibited a hydrogen adsorption capacity more than three times higher than that of HB alone or LiB₂ that were not modified with lithium.

### 2-2. Evaluation of IR Spectrum

For Li/HB and HB, IR spectra were measured by the attenuated total reflection (ATR) method using a Bruker Alpha spectrometer (ALPHA II, manufactured by Bruker, Billerica, MA, USA). The measurements were conducted in a glove box under an argon atmosphere and at room temperature (25°C), with the number of accumulations set to 16.

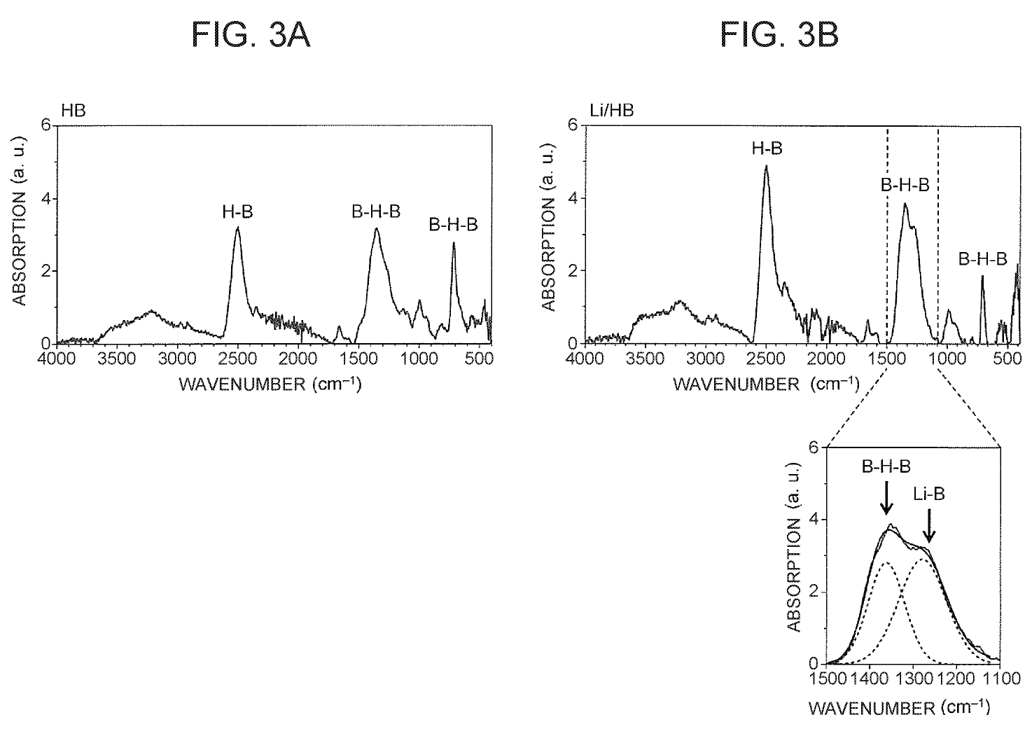

The results are illustrated in FIGS. 3A and 3B. It was found, from FIG. 3B, that the obtained Li/HB had an absorption peak (Iab) in the range from 1100cm⁻¹or more to 1500cm⁻¹or less.

The absorption peak (Iab) of the obtained Li/HB was not a single absorption peak but rather a peak consisting of overlapping two absorption peaks, namely, an absorption peak (Ia) having a maximum value in the range from 1300cm⁻¹ or more to1400cm⁻¹ or less, and an absorption peak (Ib) having a maximum value in the range from 1200cm⁻¹ or more to 1300cm⁻¹or less (around 1280 cm⁻¹).

The area ratio (Ia/Ib) between the separated absorption peak (Ia) and absorption peak (Ib) was 0.68.

In addition, in FIG. 3A, in the IR spectrum of HB measured under the same conditions, an absorption peak was observed in the range from1100cm⁻¹ or more to 1500 cm⁻¹ or less, but this absorption peak was a single peak having a maximum value in the range from 1300cm⁻¹ or more to1400cm⁻¹ or less.

Accordingly, the peak (Ia) is considered to be an absorption peak based on the vibration of B-H-B, and the peak (Ib) is considered to be an absorption peak based on the vibration of Li-B.

From these results, it was found that, in the obtained Li/HB, lithium was uniformly dispersed at the atomic level in the hydrogen boride without being ionized.

### 2-3. Evaluation of EEM Spectrum

For Li/HB and HB, excitation-emission matrix (EEM) spectra were measured with a fluorescence spectrophotometer Duetta (manufactured by Horiba, Ltd.). For the measurement, a solution was prepared by dispersing each sample in acetonitrile at a concentration of 1 mg/mL, and the measurement was conducted using a 1‑cm cell.

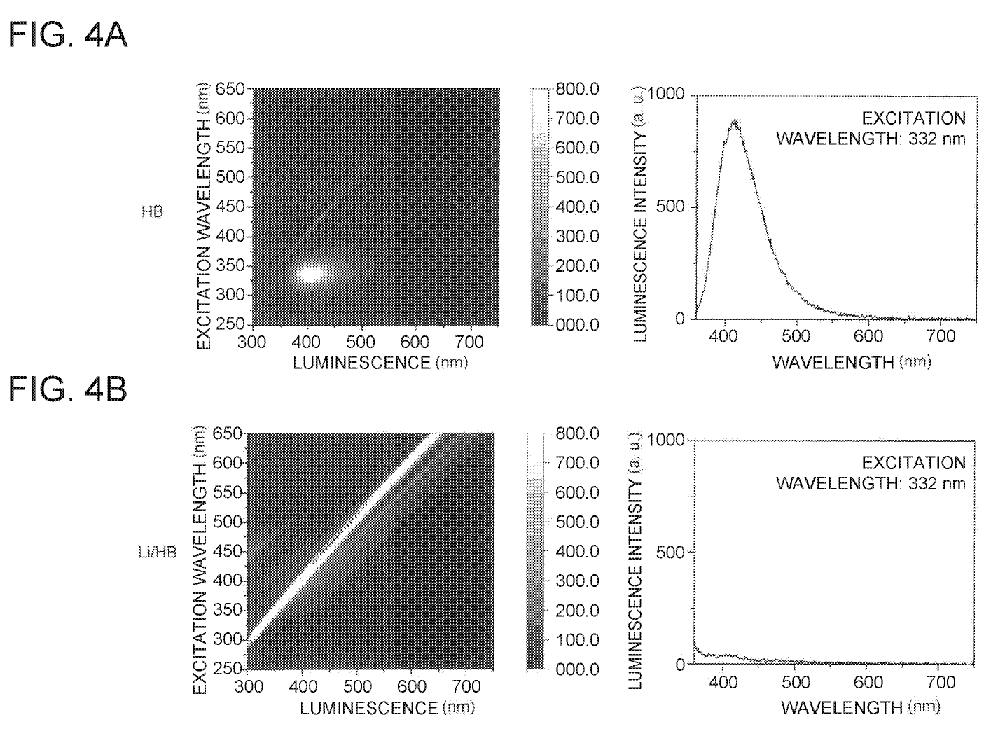

The results are illustrated in FIGS. 4A and 4B. It was found, from FIGS. 4A and 4B, that the obtained Li/HB did not exhibit any luminescence.

HB exhibited luminescence having a maximum peak around 400 nm when irradiated with light of a wavelength of 332 nm.

Accordingly, since Li/HB did not exhibit luminescence, it was found that Li/HB was a substance having different properties from HB.

### 2-4. Evaluation of TPD

For Li/HB and HB, the hydrogen desorption capacity from the compound was measured with an apparatus in which a high‑sensitivity differential thermal balance (STA‑2500 Regulus, manufactured by NETZSCH, Tokyo, Japan) was combined with a quadrupole mass spectrometer (Microvision 2, manufactured by MKS Instruments). Ten milligrams of each sample was weighed into an alumina cup, and heated at a heating rate of 10 K/min with STA‑2500 Regulus. Hydrogen generated simultaneously with the heating was quantified with Microvision 2.

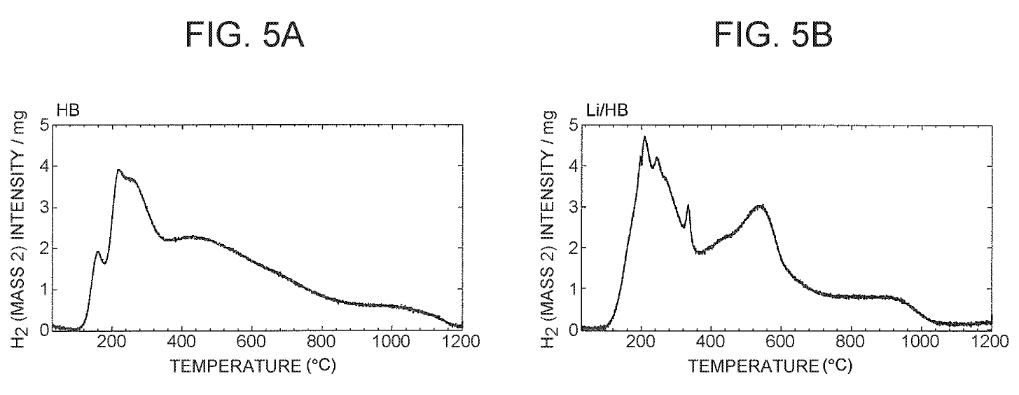

The results are illustrated in FIGS. 5A and 5B. It was found, from FIGS. 5A and 5B, that the obtained Li/HB (FIG. 5B) had, in addition to a hydrogen desorption peak at 200°C that was also observed in HB (FIG. 5A), a hydrogen desorption peak also around 550°C.

From the comparison between an integrated intensity obtained after subtracting the background in the TPD measurement of Li/HB (10 mg) and the calibration curve, it was found that Li/HB desorbed 0.35 ± 0.03 mmol of H₂ (0.70 ± 0.06 mmol in terms of H).

From the results of ICP and TPD, the molar ratio of H, B, and Li in Li/HB can be calculated as follows. First, the molar ratio of B and Li in Li/HB is 0.66:0.34. The total amount of boron and lithium in Li/HB (10 mg) is 10 - 0.70 = 9.3 ± 0.06 mg. Accordingly, (B + Li) is 9.3/(10.8 × 0.66 + 6.9 × 0.34) = 0.98 mmol (calculated by using atomic weights of 10.8 for B and 6.9 for Li). Accordingly, since H:B:Li = 0.7:(0.66 × 0.98):(0.34 × 0.98), the molar ratio of H, B, and Li in Li/HB is H:B:Li = 1 ± 0.09:0.92 ± 0.09:0.48 ± 0.09.

What is claimed is:

1. A lithium-modified hydrogen boride comprising lithium and hydrogen boride,
wherein in measurement of an IR spectrum by an attenuated total reflection method, an absorption peak is observed in a range from 1100 cm⁻¹ or more to 1500 cm⁻¹ or less, and
the absorption peak is overlapping peaks consisting of an absorption peak (Ia) having a maximum value in a range from 1300 cm⁻¹ or more to 1400 cm⁻¹ or less, and an absorption peak (Ib) having a maximum value in a range from 1200 cm⁻¹ or more to 1300 cm⁻¹ or less.

2. The lithium-modified hydrogen boride according to claim 1, wherein an area ratio (Ia/Ib) between the separated absorption peak (Ia) and absorption peak (Ib) is in a range from 0.5 or more to 0.8 or less.

3. The lithium-modified hydrogen boride according to claim 1,
wherein a molar ratio (B/Li) between boron and lithium calculated by ICP is in a range of 0.8 or more, and
a molar ratio (H/B) between hydrogen calculated by TPD and boron calculated by ICP is in a range of 1.2 or less.

4. The lithium-modified hydrogen boride according to claim 1, having, in a temperature-hydrogen intensity curve obtained by TPD measurement, a hydrogen desorption peak with a peak top present in a range from 500°C or more to 600°C or less.

5. A method for producing a lithium-modified hydrogen boride comprising lithium and hydrogen boride, the method comprising mixing lithium metal and hydrogen boride under applied shear force.

6. The method according to claim 5, wherein the mixing is performed under an inert atmosphere with a mortar and pestle.
